(19) United States
(12) Patent Application Publication
(10) Pub. No.: US 2007/0224568 A1
(43) Pub. Date: Sep. 27, 2007

(54) Tooth orthopedic appliance

(76) Inventor: Fu-Yi Lin, Taipei (TW)

Correspondence Address: BIRCH STEWART KOLASCH & BIRCH, PO BOX 747, FALLS CHURCH, VA, 22040-0747, US

(21) Appl. No.: 11/388,929

(22) Filed: Mar. 27, 2006

(51) Int. Cl. A61C 3/00

(52) U.S. Cl. 433/8

(57) ABSTRACT

A tooth orthopedic appliance has a bracket, a plurality of middle supporting portions and a plurality of side wing portions. The bracket is connected to a surface of the tooth, wherein a base is provided on a middle part of the bracket. A main wire trench is utilized to locate a correcting wire. The plurality of middle supporting portions are located respectively at a middle part of two protruding portions of the bracket, wherein the middle supporting portions are parallel to the bracket and perpendicular to the main wire trench. A wire holding slot is formed in between the bracket and every middle supporting portion for hooking a holding wire. A notch is defined by sidewalls of the middle supporting portions and the side wing portions in order to locate the holding wire for locking a top portion of the correcting wire such that an unfastened condition is formed.

### BACKGROUND OF THE INVENTION

1. Field of Invention

The present invention relates generally to an improved structure of a tooth orthopedic appliance. More particularly, the present invention relates to an improved supporting structure of an orthopedic appliance that can be used to support, align, or hold the teeth in a correct position.

2. Description of the related Art

The convectional supporting structure of an orthopedic appliance such as, the appliance “Edgewise orthodontic bracket” disclosed in U.S. Pat. No. 5,470,228 shown in FIG. 1. The edgewise orthodontic bracket comprises a base 101 located on a middle portion of an edgewise bracket 10. Two corresponding protrusions are formed on a top part of the base 101, wherein a central leg portion 20 is provided on a central part of the two protrusions. Wing tip portions 30 are formed respectively on each of the mesial and distal sides of the central leg portion 20 such that a T-shaped structure is formed. A long shaped slot 103 is located in between the wing tip portions, the central leg portion 20 and the edgewise bracket 10. An archwire slot 102 is defined by the sidewalls of the two protrusions.

FIG. 2 shows that when the edgewise orthodontic bracket is in use, a plurality of edgewise brackets 10 are integrated onto the front and side surfaces of the teeth 6. An elastic mean 4 is hooked onto the two long shaped slots 103 of every edgewise bracket 10. A correcting wire 5 is inserted into the archwire slot 102 of every edgewise bracket 10 in order to utilize the elastic mean 4 to bend forward from both sides of the long-shaped slots 103 (from both external sides of the wing tip portions 30) such that the correcting wire 5 can be hooked onto every tooth 6. The edgewise orthopedic bracket taught in the prior art actually utilizes the elastic mean 4 to bend forward and perpendicular to the both external sides of the wing tip portions 30.

When the correcting wire 5 is hooked onto the bracket, the edgewise bracket is only in contacted with front portion of the correcting wire 5 after the formation as shown in FIG. 3. In other words, there is little contact area with the correcting wire 5 resulting the friction force between the correcting wire and the elastic mean is low. Therefore, the connection between edgewise bracket 10 and the correcting wire 5 is poor that results the orthopedic bracket to disalign from the teeth. The orthodontic effect of the teeth is less effective. The present invention provides an improved orthopedic appliance that can overcome those problems and increase the orthodontic efficiency.

### SUMMARY OF THE INVENTION

It is an object of the present invention provides an improved structure of a tooth orthopedic appliance, wherein the improved structure comprises a bracket, a plurality of middle supporting portions and a plurality of side wing portions. The bracket is connected to a surface of the tooth, wherein a base is provided on a middle part of the bracket. A main wire trench is utilized to locate a correcting wire.

The plurality of middle supporting portions are located respectively at a middle part of two protruding portions of the bracket, wherein the middle supporting portions are parallel to the bracket and perpendicular to the main wire trench. A wire holding slot is formed in between the bracket and every middle supporting portion for hooking a holding wire. The plurality of side wing portions are located respectively on both external sides of the middle supporting portions, and are formed slanting extensions in between sidewalls of the middle supporting portions and end parts of the main wire trench.

The slanting extensions of the side wing portions can be utilized as a guide for bending a holding wire along both sides of the wire holding slot and directing toward a direction of the main wire trench in such that the holding wire is in a close contact with both sides of the correcting wire to lock the correcting wire in its place from a top direction in order to increase friction and strong bonding effect between the correcting wire and the holding wire.

A bending hook is formed on the every slanting extension of the side wing portion, and is bended toward a direction of the bracket in order to increase contact friction between the side wing portions and the holding wire. A notch is formed and defined by sidewalls of the middle supporting portions and the side wing portions in order to locate the holding wire for locking a top portion of the correcting wire such that an unfasten condition is formed.

Both the foregoing general description and the following detailed description are exemplary and explanatory only and are restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 is a 3-D view of a conventional edgewise tooth orthopedic appliance;

FIG. 2 is a schematic view of the conventional edgewise tooth orthopedic appliance utilized on the teeth;

FIG. 3 is a partial side view of contacting relation between an edgewise bracket, an elastic mean, a correcting wire of the conventional edgewise tooth orthopedic appliance with a tooth;

FIG. 4 is a 3-D view of an improved structure of a tooth orthopedic appliance of a preferred example of the present invention;

FIG. 5 is diagram showing 2-D front view of an improved tooth orthopedic appliance;

FIG. 6 is a side view of an improved tooth orthopedic appliance of the preferred example of the present invention;

FIG. 7 illustrates a diagram of an improved structure of a tooth orthopedic appliance utilized on the teeth in accordance with a first preferred example of the present invention;

FIG. 8 is a front view showing that an holding wire is utilized to tighten an improved tooth orthopedic appliance onto the teeth in accordance with the first preferred example of the present invention;

FIG. 9 is a side view of FIG. 8;

FIG. 10 illustrates a front view of an holding wire utilized to unfasten a correcting wire of the improved tooth orthopedic appliance in accordance with the first preferred example of the present invention;

FIG. 11 is a side view of FIG. 10;

FIG. 12 is schematic view of an improved structure of a tooth orthopedic appliance in accordance with a second preferred example of the present invention;

FIG. 13 is a schematic top view of the improved tooth orthopedic appliance;

FIG. 14 is a schematic side view of the improved tooth orthopedic appliance;

FIG. 15 is a front view showing that an holding wire is utilized to tighten an improved tooth orthopedic appliance onto the teeth in accordance with the second preferred example of the present invention;

FIG. 16 is a side view of FIG. 15;

FIG. 17 illustrates a front view of an holding wire utilized to unfasten a correcting wire of the improved tooth orthopedic appliance in accordance with the second preferred example of the present invention;

FIG. 18 is a side view of FIG. 17.

### DESCRIPTION OF THE PREFERRED EMBODIMENTS

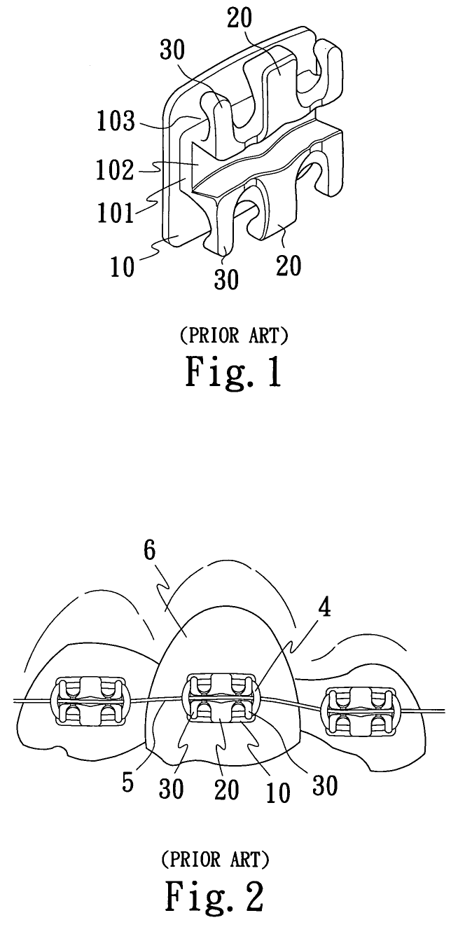

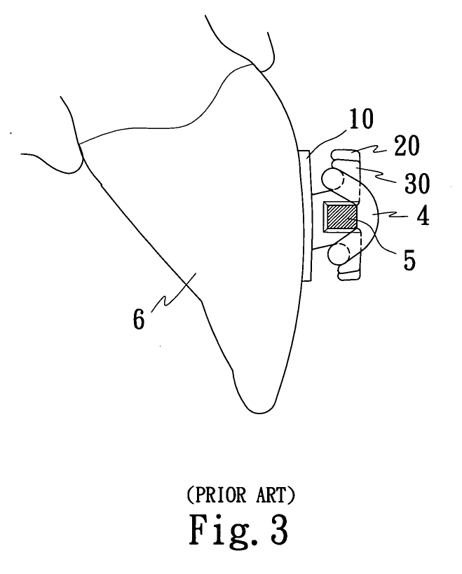

FIGS. 1-3 show the conventional tooth orthopedic appliance with a defected structural design resulting low efficiency.

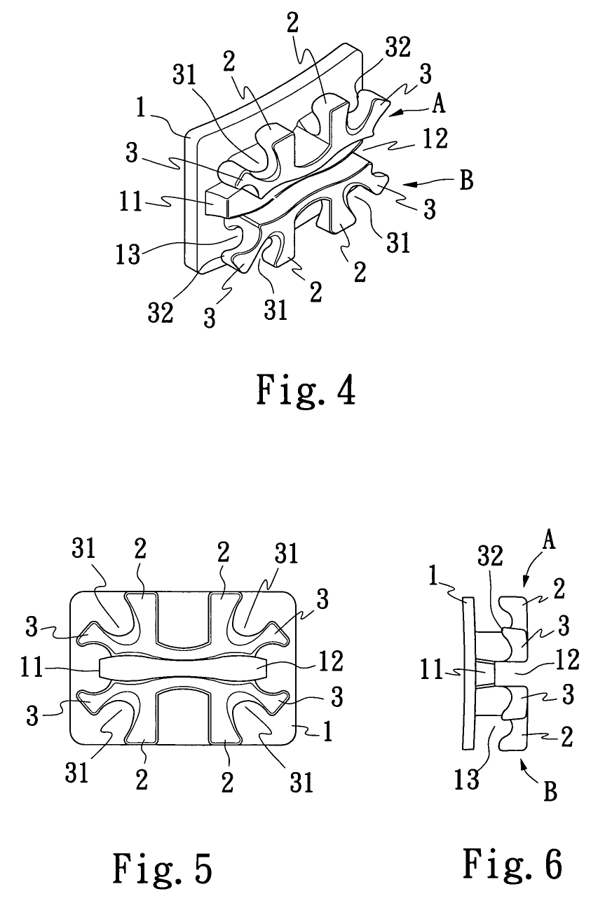

FIG. 4 is a 3-D view of an improved structure of a tooth orthopedic appliance of a first preferred example of the present invention. FIGS. 5 and 6 are diagrams showing 2-D front and side views of an improved structure of a tooth orthopedic appliance of the first preferred example of the present invention. The improved tooth orthopedic appliance of the present invention comprises a bracket 1, a middle supporting portion 2 and a side wing portion 3. A base 11 is provided at a middle part of the bracket 1. Two protruding portions A and B are formed respectively and correspondingly on each side of the base 11.

A main wire trench 12 is formed and defined by the sidewalls of the two protruding portions A and B. A plurality of middle supporting portions 2, which are located and extended respectively on the two protruding portions A and B are parallel to the bracket 1 and are perpendicularly to the main wire trench 12. A wire holding slot 13 is formed in between the bracket 1 and every middle supporting portion 2. A plurality of side wing portions 3 are located respectively on both sides of the middle supporting portions 2 such that slanting extensions are formed in between the sidewalls of the middle supporting portions 2 and end portions of the main wire trench 12. A notch 31 is defined by sidewalls of the middle supporting portions 2 and the side wing portions 3. A bending hook 32, which is bended toward the direction of the bracket 1 is formed on the slanting extension of the side wing portion 3.

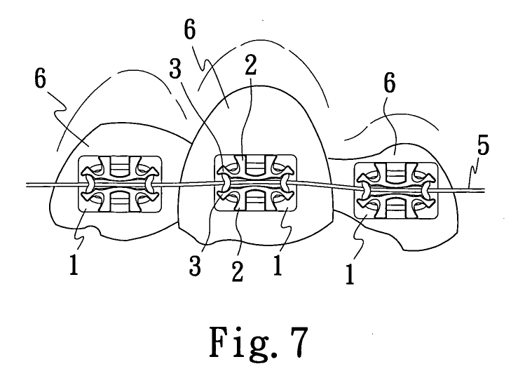

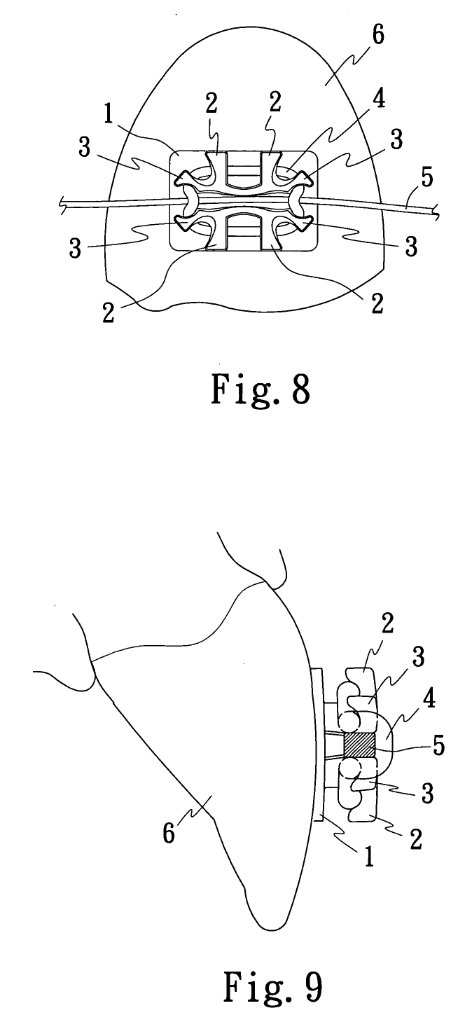

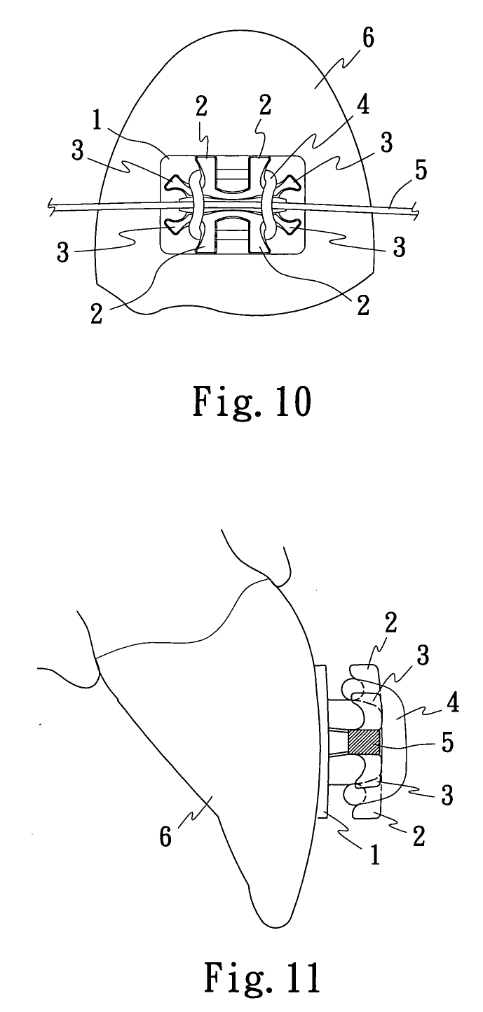

FIG. 7 illustrates a diagram of an improved structure of a tooth orthopedic appliance utilized on the teeth in accordance with the first preferred example of the present invention. FIGS. 8 and 9 show that an holding wire is utilized to tighten an improved tooth orthopedic appliance onto the teeth in accordance with the first preferred example of the present invention. FIGS. 10 and 11 illustrate that a holding wire can be utilized to unfasten the improved tooth orthopedic appliance. The plurality of brackets 1 are respectively connected to front and side surfaces of the teeth 6 such that a holding wire 4 is hooked into the two wire holding slots 13 of every bracket 1. A correcting wire 5 is inserted into the main wire trench 12 of the bracket 1, and the holding wire 4 is utilized to bend along the external sides of the wire holding slots 13 such that the correcting wire 5 can be hooked on the orthopedic appliance and is connected respectively to every tooth 6.

When the holding wire 4 is bended along both external sides of the side wing portion 3. and directed toward the main wire trench 12, the slanting extension of the side wing portion 3can be used as a guide to adhere the holding wire 4 onto the correcting wire 5 and extend to the both sides of the correcting wire 5. The holding wire 4 can lock the correcting wire 5 from a top position such that the friction of the contact area of the holding wire 4 and the correcting wire 5 can be increased. The contact area between the bending hook 32 of the side wing portions 3 and the holding wire 4 can be increased so that a tightened connection between the correcting wire 5 and the bracket 1 can be achieved. If the holding wire 4 is hooked through two notches 31 and bended toward the main wire trench 12, the correcting wire 5 can only be locked from a top portion. In other words, the connection between the correcting wire 5 and the bracket 1 is an unfastened condition that is applied to a patient for certain circumstance.

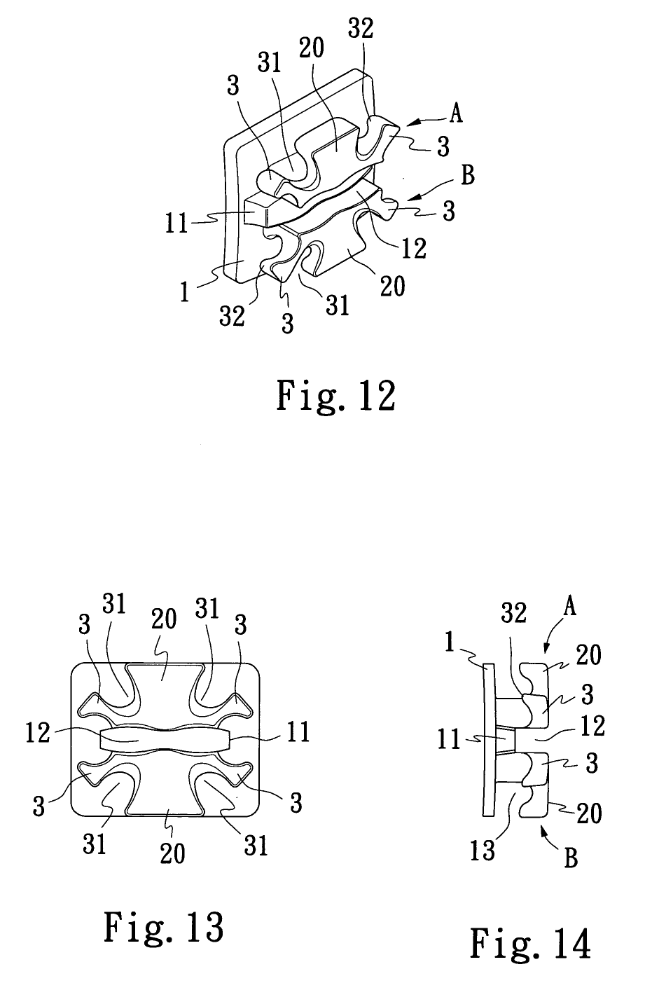

FIGS. 12-14 are schematic views of an improved structure of a tooth orthopedic appliance in accordance with a second preferred example of the present invention. The structure of the second preferred example is similar to the first preferred example mentioned above. The improved tooth orthopedic appliance of the second preferred example comprises a bracket 1, a middle supporting portion 20 and a side wing portion 3. A main wire trench 12 is provided on a top of a base 11 of the bracket 1, wherein the middle supporting portion 20 is formed respectively on a middle portion of both sides of the main wire trench 12 (the middle supporting portion 20 can replace those middle supporting portions 2 disclosed in first preferred example). A wire holding slot 13 is defined by sidewalls of the bracket 1 and the two middle supporting portions 20 as shown in FIG. 14. A plurality of side wing portions 3 are located respectively on both external sides of the middle supporting portion 20, and the side wing portions 3 are figured into slanting extensions along the sidewalls of the middle supporting portions 20 and end portions of the main wire trench 12. A notch 31 is formed in between every side wing portion 3 and the middle supporting portion 2. A bending hook 32, which is formed on the every slanting extension of the side wing portion 3 is bended toward the bracket 1.

The middle supporting portions 20 of the second preferred example comprise narrower widths than the middle supporting portions 2 of the first preferred example such that the whole structure of the bracket 1 of the second preferred example has smaller width and smaller area than the structure of the first preferred example.

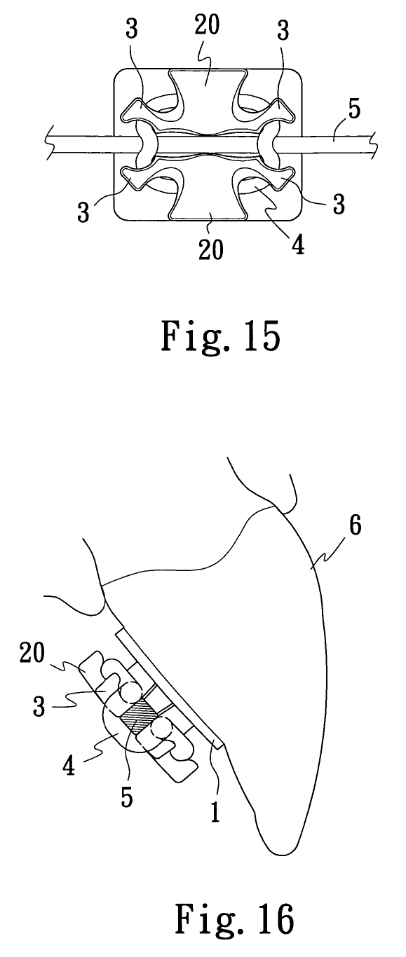

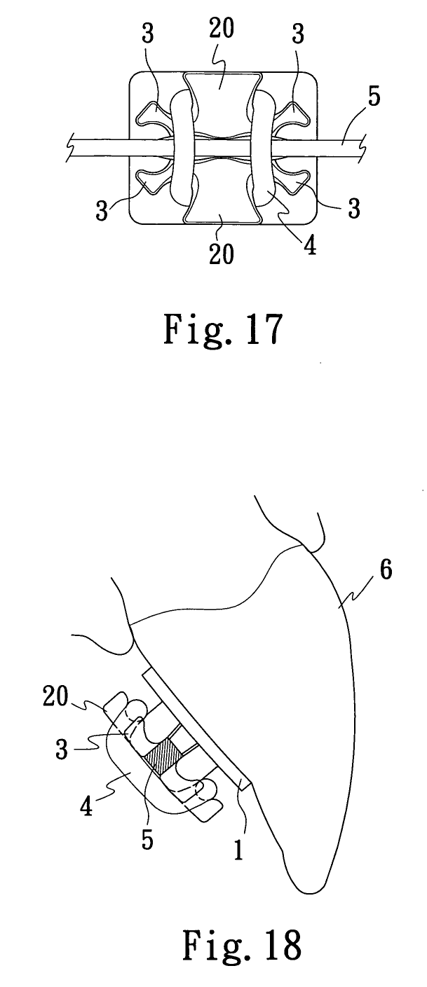

FIGS. 15 and 16 show that a holding wire is utilized to tighten an improved tooth orthopedic appliance onto the teeth in accordance with the second preferred example of the present invention. FIGS. 17 and 18 illustrate that a holding wire can be utilized to unfasten the improved tooth orthopedic appliance. Since the tooth orthopedic appliance of the second preferred example has smaller width and area, the holding wire 4 and the correcting wire 5 can be integrated with the bracket 1, the middle supporting portions 20 and the side wing portions 3 to form a different structure compared to the structure disclosed in the first preferred example when the improved tooth orthopedic appliance is applied onto a set of teeth.

The above-mentioned examples, it is clear that the present invention provides an improved tooth orthopedic appliance that can overcome those defaults of the prior art and provide better orthodontic efficiency.

The forgoing is considered illustrative of the principles of the invention. As variations and related embodiments may occur to those skilled in the art, it is to be appreciated the invention, and all suitable modifications and equivalents, are only to be limited by the scope of the claims following hereinafter.

1. A structure of a tooth orthopedic appliance, comprising:
a bracket, connecting to a surface of the tooth wherein a base is provided on a middle part of the bracket, two protruding portions are provided symmetrically on two sides of the base, and a main wire trench is located between the two protruding portions to receive a correcting wire;
a plurality of middle supporting portions, locating respectively at a middle part of the two protruding portions of the bracket, wherein the middle supporting portions extend outward along a direction being parallel to the bracket and perpendicular to the main wire trench, so that a holding wire slot is formed in between the bracket and every middle supporting portion for hooking a holding wire; and
a plurality of side wing portions, locating respectively on both external sides of the middle supporting portions and forming a slanting extension in between the middle supporting portions and end parts of the main wire trench, the side wing, portions extending in a direction offset from the middle supporting portions wherein the side wing portions can be utilized as a slanting guide for bending the holding wire from both sides of the wire holding slot in a direction toward die main wire trench in such that the holding wire is in a close contact with both sides of the correcting wire and provides a pressure on a top side of the correcting wire in order to increase friction and bonding strength between the correcting wire and the holding wire.

2. The structure of claim 1, wherein a bending hook is formed on each of the slanting extensions of the side wing portion, and is bended toward the bracket in order to increase contact surface between the side wing portions and the holding wire.

3. The structure of claim 1, wherein a notch is formed and defined by sidewalls of the middle supporting portions and the side wing portions in order to allow the holding wire to pass through and to provide the pressure on the top portion of the correcting wire such that an relaxed fastening condition is formed.

4. The structure of claim 1, wherein the main wire trench extends to exhibit a wave-shaped form.

5. The structure of claim 1, wherein tops of the middle supporting portions are non-parallel with tops of the plurality of side wing portions.

6. The structure of claim 1, wherein the holding wire extends in a first direction behind the middle supporting portions, in a second direction behind the side wing portions and in a third curving direction from the side wing portions of one of the two protruding portions along one side, across a top and then along another side of the correcting wire to a side wing portion of another one of the two protruding portions, the first and second directions being non-parallel.
